(19) United States
(12) Patent Application Publication
(10) Pub. No.: US 2012/0155717 A1
(43) Pub. Date: Jun. 21, 2012

(54) IMAGE SEARCH INCLUDING FACIAL IMAGE

(75) Inventors: Yue Ma, Bellevue, WA (US); Justin Hamilton, Bellevue, WA (US); Qifa Ke, Cupertino, CA (US)

(73) Assignee: MICROSOFT CORPORATION, Redmond, WA (US)

(21) Appl. No.: 12/970,314

(22) Filed: Dec. 16, 2010

(51) Int. Cl. G06K 9/00

(52) U.S. Cl. 382/118

(57) ABSTRACT

A method and apparatus is provided for performing image matching. The method includes comparing a face in a first image to a face in each of a set of stored images to identify one or more face-matching images that include similar facial features to the face in the first image. Next, the first image is compared to each of the face-matching images to identify one or more resulting images that are spatially similar to the first image. Accordingly, the resulting image or images have similar facial features and similar overall or background features to those in the first image. For example, if the query image is of a playground with a child swinging on a swing, the image matching technique can find other images of the same child in a setting that appears similar.

### BACKGROUND

Image matching is a fundamental technique used in applications like computer vision, object recognition, motion tracking, 3D modeling, etc. Image matching is performed to check whether two images have the same visual content. However, the two images need not be exactly the same. For example, one image may be rotated or taken from a different viewpoint as compared to the other image, it may be a zoomed version of the other image, or there might be distracting elements in the image. Furthermore, the two images may be taken under different lighting conditions. Despite such variations in the two images, they contain the same content, scene or object. Therefore, various image matching techniques are used to match images effectively.

In an example scenario, image matching may be performed to identify one or more matches against a query image provided by a user. The query image provided by the user can be, for example an image of a movie poster, a picture of an outdoor holiday spot, a photograph of a famous personality, etc. Furthermore, a server, for example a personal computer or any data processing unit that is present in a communication network, can include a database of thousands of images from a number of sources such as magazines, posters, newspapers, the Internet, billboard advertisements, etc. The query image from the user can be matched against the images stored in the database to identify appropriate matching images corresponding to the query image.

With today's technology, computer users have easy access to thousands of digital images. As technology continues to advance, more and more computer users will have access to more and more images. However, as the number of images to which computer users have access increases, so does the difficulty in locating a particular image. An image search engine should be able to identify candidate images from a query image, even where the candidates have changes in scale, are cropped differently, or where the query/candidate image is partially blocked (by another image) or only partially duplicated.

Various image matching techniques are available to identify various overall image features in the scene and match those image features against image features in the stored images. For instance, such image matching techniques may take a query image of a golf course and find other images of a golf course. In this way images may be found that have similar overall features to a query image. If, for example, the query image of the golf course includes a person putting, for instance, these image matching techniques may find other similar images in which a person is putting or otherwise present on the golf course. However, a difficulty arises when image-based searching is used to match an image that includes a person's face. Such a situation may arise, for instance, if a user submits a query image of a scene such as a golf course with a person putting and wishes to find similar image that includes that same person. In this case the image matching techniques may find images with some similar overall features in the background or the like, but the faces will not match. As an example, a query image of a playground may include a child swinging on a swing. Currently available image matching search techniques may find other images of a playground that include a swing, but the child will generally not be the same as the child in the query image.

### SUMMARY

In one implementation, a method and apparatus is provided for performing image matching. The method begins by comparing a face in a first image to a face in each of a set of stored images to identify one or more face-matching images that include similar facial features to the face in the first image. Next, the first image is compared to each of the face-matching images to identify one or more resulting images that are spatially similar to the first image. Accordingly, the resulting image or images have similar facial features and similar overall or background features to those in the first image. For example, if the query image is of a playground with a child swinging on a swing, the image matching technique can find other images of the same child in a setting that appears similar.

In another implementation, a system for implementing image matching is provided. Among other things, the system includes a search module that is configured to: identify the presence of at least one face in the query image; determine a similarity of the face to the faces in a set of stored images based on one or more pre-established criteria; determine a similarity of non-facial features in the query image to non-facial features in a subset of the stored images which each have a face with at least a prescribed degree of similarity to the face in the query image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flowchart showing an image-based search process.

FIG. 2 is a schematic block diagram of an illustrative system 200 for implementing an image-based search.

FIG. 3 illustrates one example of the image search server shown in FIG. 2.

FIG. 4 is a flowchart showing one particular example of method that may be performed when a user initiates an image search.

### DETAILED DESCRIPTION

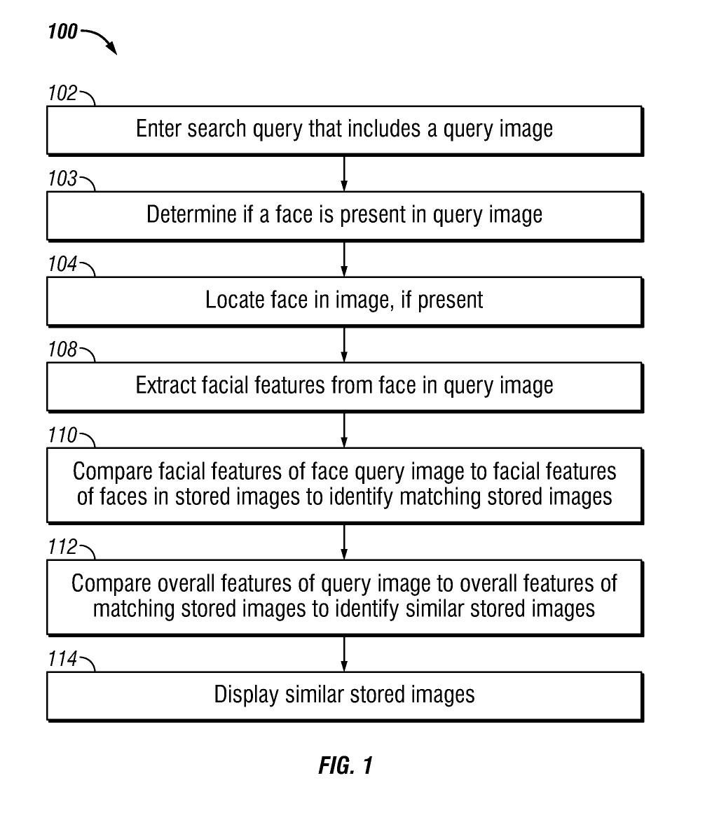

FIG. 1 is a flowchart showing an image-based search 100 according to one illustrative implementation, which is broadly applicable to any situation in which it is desired to search for images similar to one or more query images that include one or more faces. At 102, a user enters a search query. To search for images similar to a query image, a user provides a copy of the query image. The query image may be provided by inputting a query image (e.g., from a digital camera, scanner, video camera, camera phone, or other image source), designating a query image from among a plurality of stored images, selecting a query image from the Internet, or by otherwise making available a copy of an image to use as the query image. The search query may also include textual search terms to search, for example, based on age, gender, ethnicity, location, or other information which can readily and accurately be recorded in textual data. Such a text-based search may be performed independently of the image-based search, or may be performed prior to the image-based search to narrow the field of stored images to be searched during the image-based search.

Once a query image has been provided, at 103, a face detection algorithm is employed to determine if indeed one or more faces are present in the query image. Identifying the presence of a face in an image may be performed using any of a variety of algorithms. For example, as discussed in Wu, H., Chen, Q., Yachida M., Face Detection From Color Images using a Fuzzy Pattern Matching Method, IEEE Transactions on Pattern Analysis and Machine Intelligence, vol. 21, no. 6, pp. 557-563, 1999, skin color and hair color regions can be extracted from the query image using models of skin color and hair color. The extracted regions can then be compared to pre-defined head-shape models using a fuzzy theory based pattern-matching method to detect face candidates. Additional face detection techniques may be found in: C. Zhang and Z. Zhang, “Winner-Take-All Multiple Category Boosting for Multi-view Face Detection”, ECCV Workshop on Face Detection: Where are we, and what next, Crete, Greece, September 2010; and C. Zhang and P. Viola, “Multiple-Instance Pruning for Learning Efficient Cascade Detectors”, NIPS 2007, Vancouver, Canada, December 2007

Next, at 104, the query image is aligned and cropped, if necessary, to isolate the face and to conform the query image to a predetermined standard size, shape, and/or orientation angle. If more than one face is present, a dominant face (e.g., the largest) is selected. The face may be located using a conventional face detection system such as, for example, the three-step face detector described by Xiao et al. in “Robust Multi-Pose Face Detection in Images,” IEEE Trans. on CSTV, special issue on Biometrics, 14(1), p, 31-41, which is incorporated herein by reference. Face alignment and cropping also may be accomplished using any of various well known formatting techniques.

Once a face has been located, different facial features may be extracted and a similarity analysis conducted based on those features. In particular, at 108, facial features are detected and extracted for feature-based analysis. By way of example, a Bayesian tangent shape model may be used after face detection to locate feature points, such as the control points of the eyes, mouth, nose, and face shape in the query image. Details of using the Bayesian tangent shape model are described by Zhou et al. in “Bayesian Tangent Shape Model: Estimating Shape and Pose Parameters via Bayesian Inference,” Intl. Conf. on CVPR, 1, p. 109-111, which is incorporated herein by reference. The query image is then decomposed into a number of parts equal to the number of facial features used (e.g., four parts corresponding to the eye, nose, mouth and face shape, respectively) and texture, size, and shape is extracted for each part. A bank of Gabor filters with multi-scales and multi-orientations is employed to extract texture features in the manner described by Yang in “Research on Appearance-based Statistical Face Recognition,” in his PhD thesis at Tsinghua University in Beijing, China, which is incorporated herein by reference.

Another feature extraction technique that may be employed involves the use of visual words. This technique draws an analogy between feature or object-based image retrieval and text retrieval. In particular, image features are treated as visual words that can be used as queries, analogous to the use of words for text retrieval. Illustrative examples of image-features that may be extracted from a face may include one or more of the following: eyes, nose, mouth, ears and face shape. Instead of storing actual pixel values of the image in a searchable index, each feature is quantized into a visual word. The visual words may then be stored in an index such as an inverted index. The index can be searched to retrieve visual words when an image query is performed by searching the index for visual words that appear in the image query. Additional details concerning the use of visual words may be found in Zheng, Q.-F., Wang, W.-Q., Gao, W., Effective and Efficient Object-based Image Retrieval Using Visual Phrases, Proc. of the 14th annual ACM Int'l Conference on Multimedia. October 2006. ISBN:1-59593-447-2, and Zhong Wu, Qifa Ke, Jian Sun, and Heung-Yeung Shum, Scalable Face Image Retrieval with Identity-Based Quantization and Multi-Reference Re-ranking, in CVPR 2010, IEEE Computer Society, June 2010, which are hereby incorporated by reference in their entirety.

Of course, while specific examples of face location and feature extraction techniques are described herein, it should be understood that any other known location and extraction techniques could additionally or alternatively be used.

At 110, the query image compared to a plurality of stored images of faces. If the initial query included a text-based search, the query image may be compared only to the stored images matching the specified text-based search criteria. Alternatively, text-based queries, if included, may be conducted independently of the image-based query.

The comparison of the query image to the stored images may be made on an individual feature-by-feature basis. So that the comparison approximates a human's perception of interpersonal similarity, a mapping function can be determined based on a survey of one or more human assessors. The survey may be conducted ahead of time (e.g., conducted beforehand based on some pre-prepared data), or may be generated and updated in real-time (e.g., based on evaluations from the users of the image-based search) to adaptively learn the mapping function.

In one example of a survey conducted ahead of time, a number of assessors or surveyors may be asked to label similarity scores between multiple (e.g., 2500) pairs of face images, in five different perception modes: holistic, eyes, nose, mouth, and face shape. The assessors rank the similarity on any suitable scale. For instance, the scale may range from 0-3, with 0 being dissimilar and 3 being very similar. The face images may be images are stored in an image database and may include, for example, images of males and females of various ethnicities. In practice, any number of assessors and stored images could be used, with larger numbers of assessors and stored images generally providing a closer approximation to average user perception.

Once the mapping function is determined, a difference vector is computed between the query image and each of the stored images. Each difference vector is then mapped to a similarity score, which is meant to approximate human perception of similarity. The search results can then be presented based on the similarity scores.

The mapping function may then be used to calculate the matching score between the query image and each stored image in the stored image database 204 from each of the four perceptions: eyes, nose, mouth, and face shape. The results for each perception are ranked based on the matching score from high similarity to low. While four different perception modes (i.e., eyes, nose, mouth, ears and face shape) are described in the foregoing example, any number of one or more perception modes could alternatively be used. While specific techniques and equipment are described for comparing the query image to the stored images (e.g., computing vector differences, generating mapping functions, and calculating matching scores), any other suitable comparison technique could additionally or alternatively be used.

The search determines one or more stored images that match the face that has been identified in the specified query, based on a combination of text-based queries, image-based queries, and/or specified feature preference weights. Then, at 112, the query image as a whole is compared in an overall manner to the one or more resultant images found to have similar faces to the query image. In this way resultant images with a similar face can be identified which have features that are overall similar (e.g., similar on a large-scale) to those in the query image. For instance, if the face appears in a foreground of the query image and is similar to a face in a candidate resultant image, the two images will be overall or spatially similar if the background region of the query image is also similar to the background region of the candidate resultant image. As a concrete example, if the query image shows Barak Obama on a golf course, then at 110 resultant images that include Obama are identified. At 112, those resultant images are searched to identify other images of Obama in a similar setting. An example of an algorithm that may be employed to compare the overall images may be found in Manjunath, B. S., Ma, W. Y., Texture Features for Browsing and Retrieval of Image Data, IEEE Trans. on Pattern Analysis and Machine intelligence, vol. 18, no. 9, 1996.

At 114 the resultant images obtained are displayed in any appropriate manner. For example, the resultant images may be displayed in rank order based on their overall similarity score or based on the similarity score of the facial features. The displayed results may additionally or alternatively be organized based on the results of the text-based query.

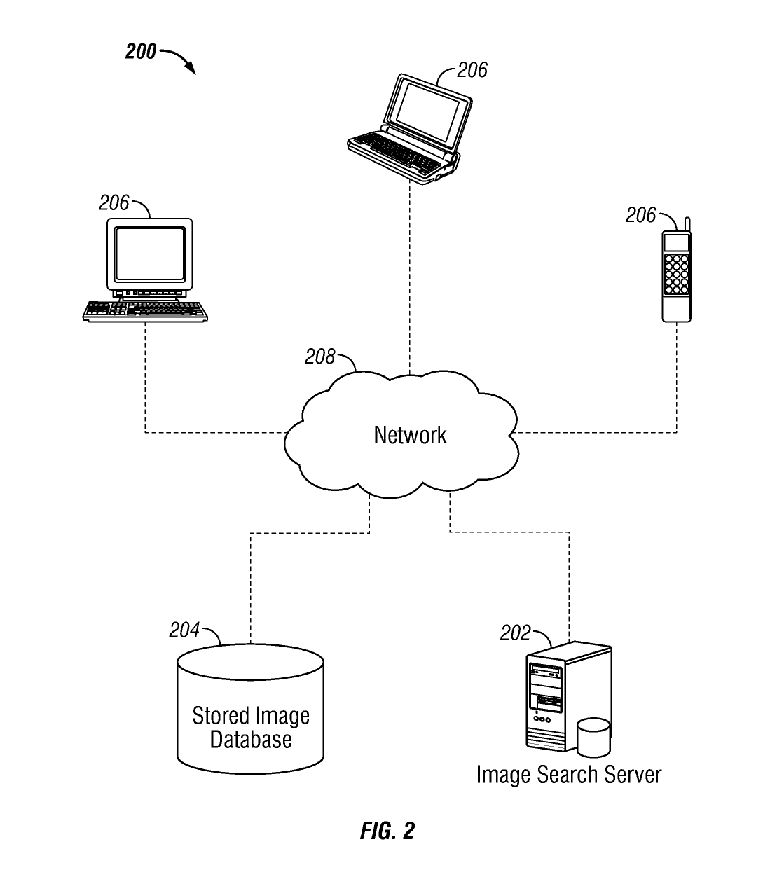

FIG. 2 is a schematic block diagram of an illustrative system 200 for implementing an image-based search, such as the one described with reference to FIG. 1. The system comprises an image search server 202 or other computing device, to which are connected one or more stored image databases 204 and various different user terminals 206 via a network 208, such as the Internet. While only one stored image database 204 is shown, stored images may be stored in any number of distributed data stores. Additionally, while the stored image database 204 is shown remotely from the image search server 202, the image database could be at least partially stored locally on the image search server 202. The location of the image storage and computing capacity of the system 200 is not important, and both storage and computing can be suitably distributed among the components of the system 200.

The user terminals 206, image search server 202 and databases 204 may be connected to the network 208 using any conventional wired connection, wireless protocol or a combination thereof. Generally, users can access the image-based search using user terminals 206, which may be any sort of computing device, such as a desktop personal computer (PC), a laptop computer, a personal digital assistant (PDA), a smartphone, a pocket PC, or any other mobile or stationary computing device.

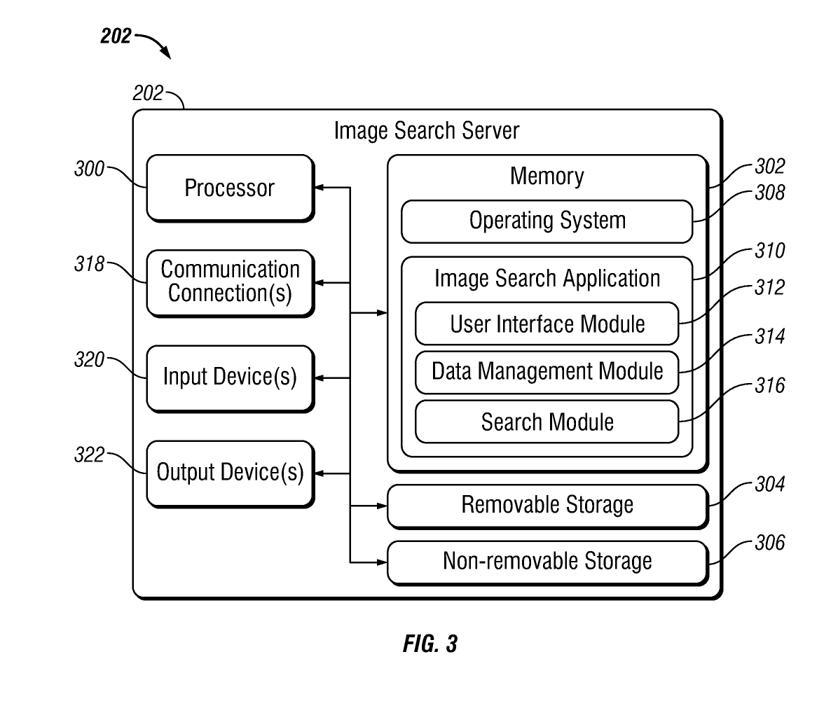

FIG. 3 illustrates the image search server 202 of FIG. 2 in more detail. The image search server 202 may be configured as any suitable computing device capable of implementing an image-based search. In one exemplary configuration, the image search server 202 comprises at least one processing unit 300 and memory 302. Depending on the configuration and type of computing device, memory 302 may be volatile (such as RAM) and/or non-volatile (such as ROM, flash memory, etc.). The image search server 202 may also include additional removable storage 304 and/or non-removable storage 306 including, but not limited to, magnetic storage, optical disks, and/or tape storage.

Memory 302 may include an operating system 308, one or more application programs 310-316 for implementing all or a part of the image-based search, as well as various other data, programs, media, and the like. In one implementation, the memory 302 includes an image-search application 310 including a user interface module 312, a data management module 314, and a search module 316. The user interface module 312 presents the user with a graphical user interface for the image-based search, including an interface prompting a user to enter text and/or image-based query information and an interface for displaying search results to the user. The data management module 314 manages storage of information, such as profile information, stored images, and the like, and may communicate with one or more local and/or remote data stores such as stored image database 204. The search module 316 interacts with the user interface module 312 and data storage module 314 to perform search functions, such performing textual searches using conventional text search methodologies, comparing query images to stored images in, for example, the stored image database 204.

Computer storage media includes volatile and nonvolatile, removable and non-removable media implemented in any method or technology for storage of information such as computer readable instructions, data structures, program modules or other data. Memory 302, removable storage 304 and non-removable storage 306 are all examples of computer storage media. Additional types of computer storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the image search server 202 or other computing device.

The image search server 202 may also contain communications connection(s) 318 that allow the image search server 202 to communicate with the stored image database 204, the user terminals 206, and/or other devices on the network 208. Communications connection(s) 318 is an example of communication media. By way of example, and not limitation, communication media includes wired media such as a wired network or direct-wired connection, and wireless media such as acoustic, RF, infrared and other wireless media.

The image search server 202 may also include input device(s) 320 such as a keyboard, mouse, pen, voice input device, touch input device, etc., and output device(s) 322, such as a display, speakers, printer, etc. All these devices are well known in the art and need not be discussed at length here.

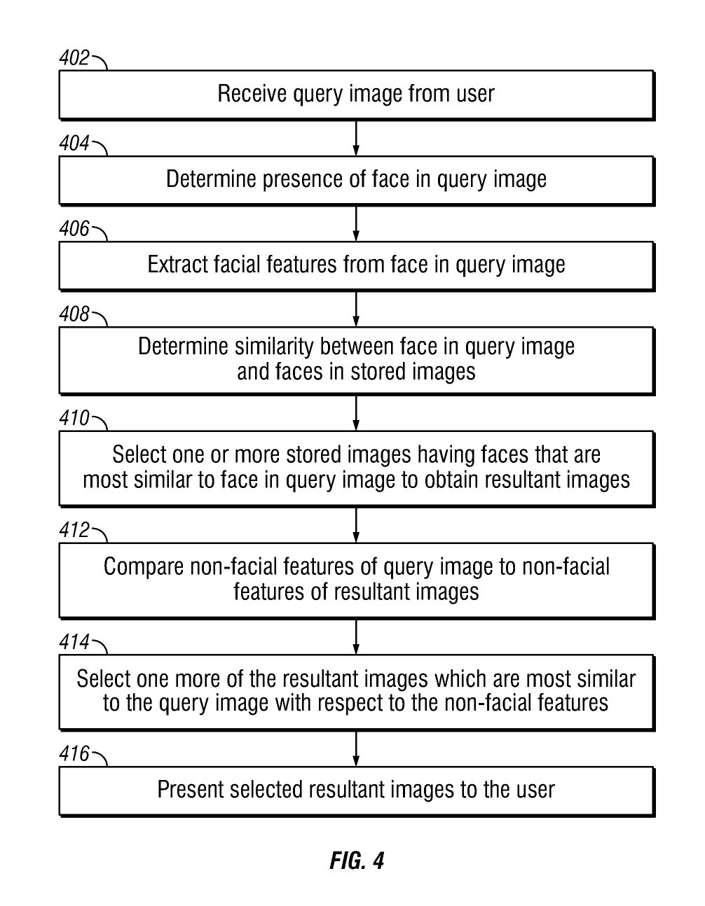

FIG. 4 is a flowchart showing one particular example of method that may be performed when a user initiates an image search. The method begins at 402 when a query that includes a query image (and possibly text) is received from the user. The image is examined at 404 to determine if one or faces are present in the query image. If multiple faces are found to be present, one of the faces is treated as the dominant face. The dominant face may be the larger of the faces that are found to be present in the image.

Next, at 406, various facial features are extracted from the face in the query image. These facial features are compared to their corresponding facial features extracted from the faces found in a series of stored images. In some implementations the comparison is performed by first quantizing each of the facial features into visual words and then comparing visual words associated with the face in the query image to the visual words associated with the faces in the stored images. Based on the comparison, the similarity is determined at 408 between the face in the query image and the faces in the plurality of stored images that include faces. At 410 a plurality of resultant images are selected from among the plurality of stored images. The resultant images are images that include a face that is determined to be similar to the face in the query image based on a first set of criteria. The criteria may involve requiring a more accurate match between the visual words associated with some features, while the matching of visual words associated with other features may only require a lesser degree of accuracy. In general a perfect match will not be required between the features in the query image and the stored images in order to treat the faces as similar.

Once a set of resultant images have been selected which include faces that are deemed similar to the dominant face in the query image, at 412 the non-facial features (e.g., background) in the query image are compared to the non-facial features in each of the resultant images to determine an overall degree of similarity therebetween. Then, at 414, one or more resultant images is selected that is determined to have an overall similarity to the non-facial features in the query. The criteria used to make the selection will generally be based in part on the algorithm that is used to perform the comparison. Finally, one or more of the selected resultant images are presented to the user at 416.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable media storing instructions executable by a computing system, comprising:
receiving from a user a query that includes a query image;
identifying a presence of at least one face in the query image;
comparing the face in the query image to a plurality of stored images that include faces;
determining a similarity of the face in the query image to the faces in the plurality of stored images that include faces;
selecting a plurality of resultant images from among the plurality of stored images, the resultant images being images that include a face that is determined to be similar to the face in the query image based on one or more first criteria;
comparing non-facial features in the query image to non-facial features in each of the resultant images to determine an overall degree of similarity therebetween;
selecting one or more resultant images that is determined to have an overall similarity to the non-facial features in the query based on one or more second criteria; and
presenting the one or more selected resultant images to the user.

2. The one or more computer-readable media of claim 1 wherein comparing the face in the query image to a plurality of stored images that include faces further comprises extracting a plurality of different facial features from the faces and comparing the faces on a feature by feature basis.

3. The one or more computer-readable media of claim 1 further comprising quantizing each of the facial features into visual words.

4. The one or more computer-readable media of claim 3 further comprising storing the visual words in an inverse index.

5. The one or more computer-readable media of claim 1 wherein the comparison of the query image to the plurality of stored images comprises computing a difference vector between the query image and each of the stored images to which it is compared.

6. The one or more computer-readable media of claim 5 further comprising mapping the difference vector to a similarity score using a mapping function that approximates human perception of similarities between facial features of different individuals.

7. The one or more computer-readable media of claim 6, wherein the mapping function is determined based on similarity scores assigned by one or more human assessors.

8. The one or more computer-readable media of claim 1 wherein the query further includes a text-based search term and further comprising selecting the one or more resultant images based at least in part on a search performed using the text-based search term.

9. The one or more computer-readable media of claim 1 wherein identifying the presence of at least one face in the query image includes extracting skin color and hair color regions from the query image and comparing the extracted regions to pre-defined head-shape models.

10. A system for implementing image matching comprising;
a memory and processor;
a user interface module, stored in the memory and executable on the processor, configured to prompt a user to provide a query image;
a data management module, stored in the memory and executable on the processor, configured to communicate with a stored image database that stores a plurality of stored images that include faces; and
a search module, stored in the memory and executable on the processor, configured to operate in conjunction with the data management module to: identify a presence of at least one face in the query image; determine a similarity of the face in the query image to the faces in the plurality of stored images based on one or more pre-established criteria; determine a similarity of non-facial features in the query image to non-facial features in a subset of the stored images which each have a face with at least a prescribed degree of similarity to the face in the query image.

11. The system of claim 10 wherein the search module is further configured to: extract a plurality of different facial features from the faces in the query image and the stored images and compare the faces on a feature by feature basis; and quantize each of the facial features into visual words.

12. The system of claim 11 wherein the search module is further configured to: compute a difference vector between the query image and each of the stored images; and map the difference vector to a similarity score using a mapping function that approximates human perception of similarities between facial features of different individuals.

13. A method for performing image matching, comprising:
comparing a face in a first image to a face in each of a plurality of stored images to identify one or more face-matching images that include similar facial features to the face in the first image;
comparing the first image to each of the face-matching images to identify one or more resultant images that are spatially similar; and
presenting the one or more resultant images to a user.

14. The method of claim 13 wherein the face appears in a foreground of the image and the first image is spatially similar to a first of the facially-matching images if a background region of the first image is similar to a background region of the first facially-matching image.

15. The method of claim 13 wherein comparing the face in the first image to a face in each of the plurality of stored images further comprises extracting a plurality of different facial features from the faces and comparing the faces on a feature by feature basis.

16. The method of claim 15 further comprising quantizing each of the facial features into visual words.

17. The method of claim 16 further comprising storing the visual words in an inverse index.

18. The method of claim 17 further comprising identifying the one or more face-matching images that include similar facial features to the face in the first image by searching the inverse index using visual words associated with the first image.

19. The method of claim 13, wherein the comparison of the first image to the plurality of stored images comprises computing a difference vector between the first image and each of the stored images.

20. The method of claim 19 further comprising mapping the difference vector to a similarity score using a mapping function that approximates human perception of similarities between facial features of different individuals.
